(19) United States
(12) Patent Application Publication
(10) Pub. No.: US 2011/0228687 A1
(43) Pub. Date: Sep. 22, 2011

(54) METHODS AND APPARATUS FOR ESTABLISHING RECIPROCAL INTER-RADIO ACCESS TECHNOLOGY NEIGHBOR RELATIONS

(75) Inventors: Amer Catovic, San Diego, CA (US); Oronzo Flore, Ostuni (IT); Manish Tripathi, San Diego, CA (US)

(73) Assignee: QUALCOMM Incorporated, San Diego, CA (US)

(21) Appl. No.: 13/046,652

(22) Filed: Mar. 11, 2011

Related U.S. Application Data
(60) Provisional application No. 61/314,451, filed on Mar. 16, 2010.

(51) Int. Cl. H04W 24/10; H04W 4/00

(52) U.S. Cl. 370/252; 370/328

(57) ABSTRACT

A method and apparatus for establishing inter-RAT reciprocal neighbor relationships. The method may include receiving a neighbor relation notification from a first entity, wherein the neighbor relation notification indicates a neighbor relationship of a first cell to a second cell, wherein the first cell uses a first RAT, and wherein the second cell uses a second RAT that is different than the first RAT, determining, by a second network entity, that a reciprocal neighbor relationship of the second cell to the first cell does not exist in a neighbor list for the second cell, and generating the reciprocal neighbor relationship.

### CLAIM OF PRIORITY UNDER 35 U.S.C. §119

The present Application for Patent claims priority to Provisional Application No. 61/314,451 entitled “Automatic Neighbor Relation Establishment Across Different Radio Access Technologies” filed Mar. 16, 2010, and assigned to the assignee hereof and hereby expressly incorporated by reference herein.

### BACKGROUND

1. Field

The present application relates generally to wireless communications, and more specifically to methods and systems for establishing reciprocal inter-radio access technology (IRAT) neighbor relationships.

2. Background

Wireless communication systems are widely deployed to provide various types of communication (e.g., voice, data, multimedia services, etc.) to multiple users. These systems may be multiple-access systems capable of supporting communication with multiple users by sharing the available system resources (e.g., bandwidth and transmit power). Examples of such multiple-access systems include Universal Mobile Telecommunications System (UMTS), code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, wireless communication systems can contemporaneously support communication for multiple mobile devices. Each mobile device can communicate with one or more network elements (e.g. base stations) via transmissions on forward and reverse links. The forward link (or downlink) refers to the communication link from base stations to mobile devices, and the reverse link (or uplink) refers to the communication link from mobile devices to base stations.

Currently, neighboring cells within a wireless communication system may be made accessible to mobile devices through a neighbor relation functionality. Further, although there are currently automatic neighbor relation (ANR) functionalities available for intra-RATs, neighbor relations and inter-RAT neighbor relations, there are no means to assure reciprocal inter-RAT neighbor relations. Currently, operators must manually determine if reciprocal inter-RAT neighbor relations should be added to a cell. Consequently, it would be desirable to have an efficient method and/or apparatus for automatically establishing reciprocal inter-RAT neighbor relationships.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with establishing inter RAT reciprocal neighbor relationships. According to one aspect, a method for establishing inter RAT reciprocal neighbor relationships is provided. The method may include receiving a neighbor relation notification from a first entity, wherein the neighbor relation notification indicates a neighbor relationship of a first cell to a second cell, wherein the first cell uses a first radio access technology (RAT), and wherein the second cell uses a second RAT that is different than the first RAT. Further, the method may include determining, by a second network entity, that a reciprocal neighbor relationship of the second cell to the first cell does not exist in a neighbor list for the second cell. Moreover, the method may include generating the reciprocal neighbor relationship.

Yet another aspect relates to at least one processor configured to establish IRAT reciprocal neighbor relationships. The processor may include a first module for receiving a neighbor relation notification from a first entity, wherein the neighbor relation notification indicates a neighbor relationship of a first cell to a second cell, wherein the first cell uses a first RAT, and wherein the second cell uses a second RAT that is different than the first RAT. Further, the processor may include a second module for determining, by a second network entity, that a reciprocal neighbor relationship of the second cell to the first cell does not exist in a neighbor list for the second cell. Moreover, the processor may include a third module for generating the reciprocal neighbor relationship.

Still another aspect relates to a computer program product comprising a computer-readable medium. The computer program product may include a computer-readable medium including a first set of codes for causing a computer to receive a neighbor relation notification from a first entity, wherein the neighbor relation notification indicates a neighbor relationship of a first cell to a second cell, wherein the first cell uses a first RAT, and wherein the second cell uses a second RAT that is different than the first RAT. The computer program product may further include a computer-readable medium including a second set of codes for causing the computer to determine, by a second network entity, that a reciprocal neighbor relationship of the second cell to the first cell does not exist in a neighbor list for the second cell. The computer program product may still further include a computer-readable medium including a third set of codes for causing the computer to generate the reciprocal neighbor relationship.

Yet another aspect relates to an apparatus. The apparatus may include means for receiving a neighbor relation notification from a first entity, wherein the neighbor relation notification indicates a neighbor relationship of a first cell to a second cell, wherein the first cell uses a first RAT, and wherein the second cell uses a second RAT that is different than the first RAT. The apparatus may further include means for determining, by a second network entity, that a reciprocal neighbor relationship of the second cell to the first cell does not exist in a neighbor list for the second cell. Moreover, the apparatus may include means for generating the reciprocal neighbor relationship.

Another aspect relates to an apparatus. The apparatus may include a communications module for receiving a neighbor relation notification from a first entity, wherein the neighbor relation notification indicates a neighbor relationship of a first cell to a second cell, wherein the first cell uses a first RAT, and wherein the second cell uses a second RAT that is different than the first RAT. Further, the apparatus may include a reciprocal inter radio access technology automatic neighbor relations (IRAT ANR) module for: determining, by a second network entity, that a reciprocal neighbor relationship of the second cell to the first cell does not exist in a neighbor list for the second cell, and generating the reciprocal neighbor relationship.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a wireless communications network with multiple Radio Access Technologies;

FIG. 2 illustrates a block diagram of a communication network according to an aspect;

FIG. 3 is another block diagram of a communication network according to an aspect;

FIG. 4 is a flowchart of an aspect of a communication network enabled to establish reciprocal inter-RAT neighbor relationships;

FIG. 5 is a call flow diagram of a communication network enabled to establish reciprocal inter-RAT neighbor relationships;

FIG. 6 illustrates an example block diagram of a network monitoring system according to an aspect;

FIG. 7 illustrates a block diagram of an example communications device that can evaluate base station efficiency in a network; and

FIG. 8 illustrates an example multiple access wireless communication system according to an aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

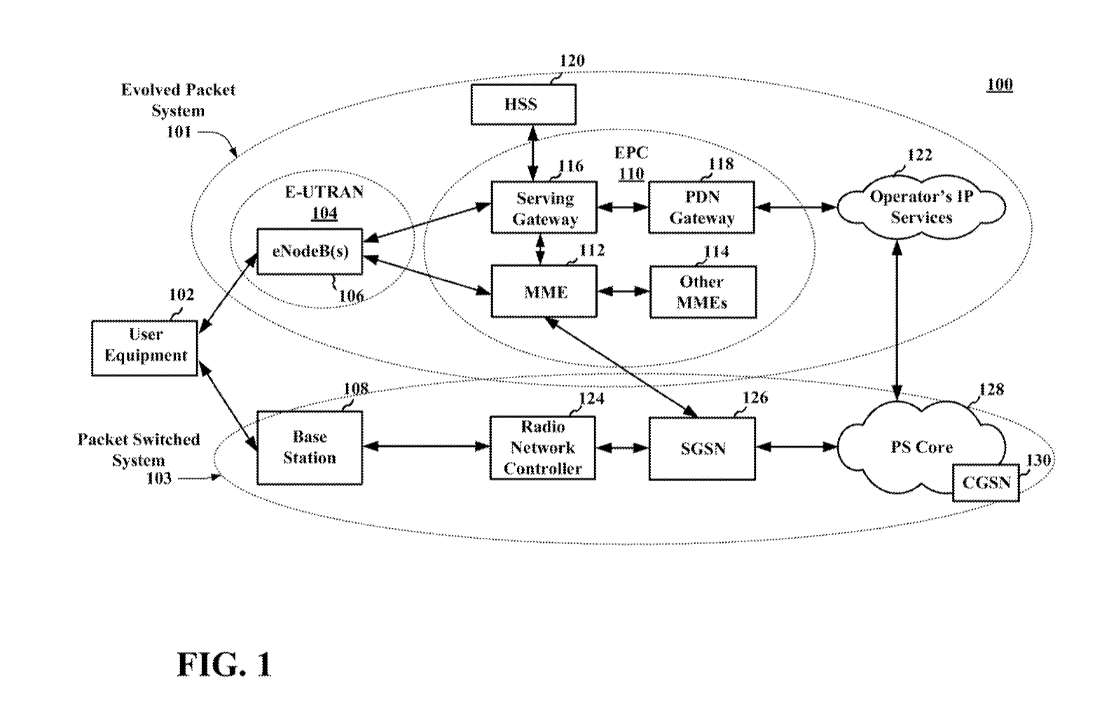

FIG. 1 is a diagram illustrating a wireless network architecture 100 employing various apparatuses. The network architecture 100 may include an Evolved Packet System (EPS) 101. The network architecture 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, such as a packet switched core (PS core) 128, a circuit switched care (CS core) 134, etc. As shown, the EPS 101 provides packet-switched services, however, as those skilled in the art will readily appreciate, the various concepts presented throughout this disclosure may be extended to networks providing circuit-switched services, such as the network associated with CS core 134.

The network architecture 100 may further include a packet switched network 103. In one aspect, the packet switched network 103 may include base station 108, base station controller 124, Serving GPRS Support Node (SGSN) 126, PS core 128 and Combined GPRS Service Node (CGSN) 130.

The E-UTRAN may include an evolved NodeB (eNB) 106 and connection to other networks, such as packet and circuit switched networks may be facilitated through a Mobility Management Entity (MME) 112. Further, through a connection between MME 112 and SGSN 126 a logical connection may be established between eNB 106 and RNC 124. The eNB 106 provides user and control plane protocol terminations toward the UE 102. The eNB 106 may be connected to the other eNBs 106 via an X2 interface (i.e., backhaul). The eNB 106 may also be referred to by those skilled in the art as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UE 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a MME 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

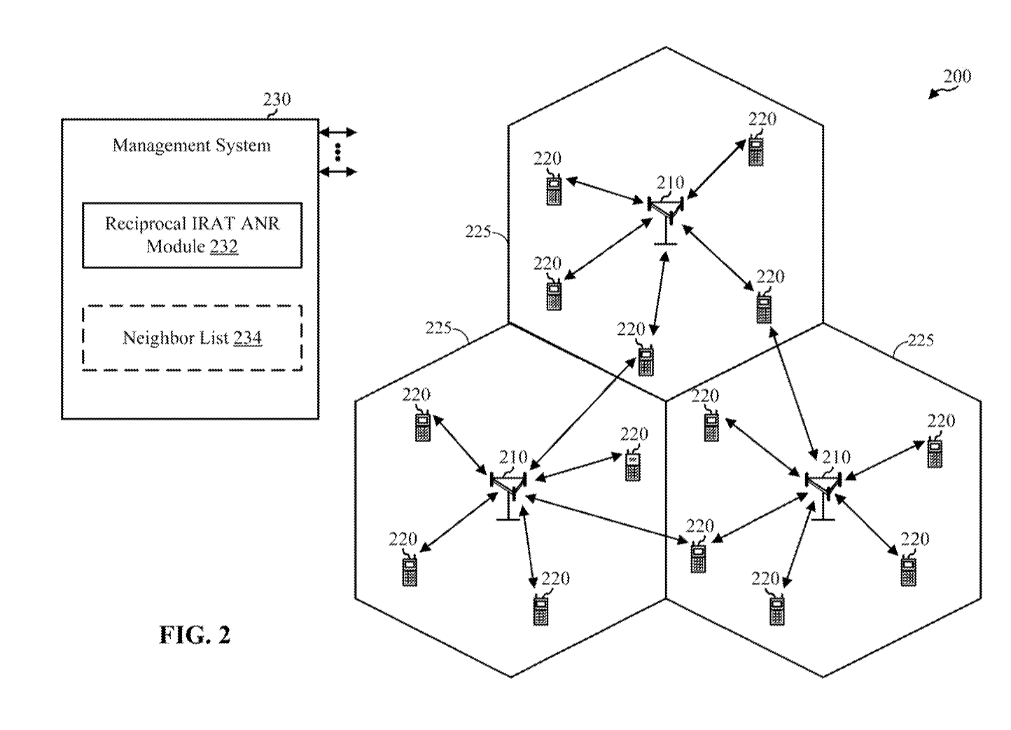

With reference to FIG. 2, a block diagram of a communication network 200 according to an aspect is illustrated. As illustrated, communication system 200 may include a number of base stations 210 that support communication for a number of wireless terminals 220 within different cells 225. A base station is a fixed station used for communicating with the terminals and can also be called an access point, a base transceiver station (BTS), a NodeB, an eNodeB or some other terminology. A terminal may be fixed or mobile and may also be called a mobile station (MS), a mobile equipment (ME), a user equipment (UE), a wireless device, a subscriber unit, or some other terminology. The terminals may be dispersed throughout the system. Each base station may communicate with any number of terminals at any given moment depending on various factors such as, for example, the number of terminals within the coverage (e.g., cell) of the base station, the available system resources, the data requirements of the terminals, and so on. A management system 230 may monitor, and/or configure the base stations. The management system 230 may be comprised within an RNC, an eNodeB, a network management system (NMS), an element management system (EMS) etc. For example, in a UMTS based network, management system 230 may be included within an RNC or may be a separate UTRAN EMS entity. In another example, in an LTE based network, management system 230 may be included within an eNodeB or may be a separate EUTRAN EMS entity.

In one aspect, management system 230 may include a reciprocal IRAT ANR module 232 to enable management system 230 to establish IRAT reciprocal neighbor relationships. In one aspect, management system 230 may include a cell NL list 234 that includes any existing neighbor relations.

In operation, management system 230 may receive a notification from a network entity in a first cell, that is using a first RAT (e.g., an LTE system), indicating that the cell associated with the management system 230 (e.g., a second cell) has been included in as a neighbor relation to the first cell. In one aspect, the network entity in the first cell may be a management system associated with the first cell. Further, the neighbor relationship may be generated in the first cell when a UE 220 associated with a NodeB 210 in the first cell, using the first RAT detects a new neighbor cell using a second RAT. The UE may provide information about the second cell, including the RAT used in the second cell, to the first cell NodeB 210. Still further, the first cell NodeB (e.g., an eNodeB) may generate a new neighbor relationship in a neighbor list (NL). The neighbor relationship may indicate the first cell as a home cell and the second cell as a neighbor cell. Thereafter, the first cell NodeB 210 may communicate the new neighbor relationship to a network management entity associated with the first cell (e.g., a EUTRAN EMS). In one aspect, the network management entity associated with the first cell may communicate the new neighbor relationship to the management system 230 associated with the second cell. In one aspect, where management system 230 is associated with an EMS for the second cell, the new neighbor relationship may be communicated using a 3GPP type 4 message. In another aspect, where management system 230 is associated with a network level NMS, the new neighbor relationship may be communicated using a 3GPP type 2 message.

The reciprocal IRAT ANR module 232 may determine if a reciprocal neighbor relationship is present in the second cell. In other words, the reciprocal IRAT ANR module 232 may look for a neighbor relationship indicating the second cell as a home cell and the first cell as a neighbor cell. Upon determining that the second cell does not have a reciprocal neighbor relationship, the reciprocal IRAT ANR module 232 may generate the new reciprocal neighbor relationship. Thereafter, IRAT ANR module 232 may add the new reciprocal neighbor relationship to the neighbor list 234 for the second cell. The updated neighbor list 234 may be communicated to network entities within the second RAT network (e.g., an RNC, NodeB 210, etc.).

As such, reciprocal neighbor relationships may be automatically generated and distributed across different RATs.

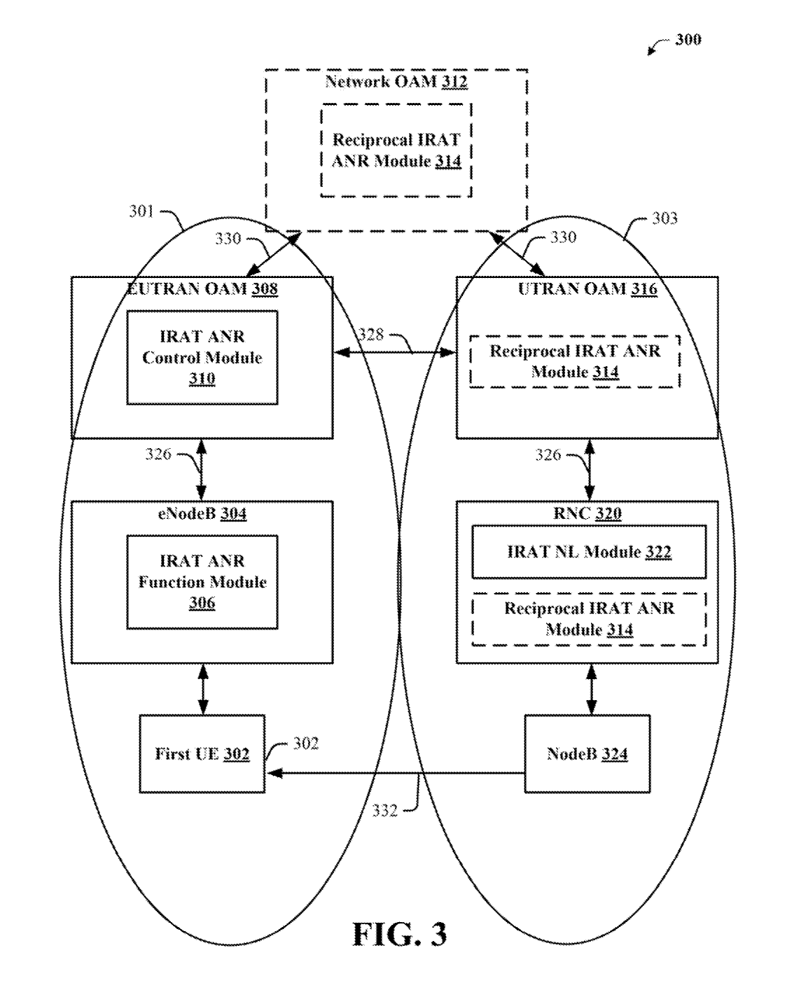

With reference to FIG. 3, a block diagram of an example communication network 300 according to an aspect is illustrated. As depicted in FIG. 3, a first RAT 301 may be an LTE system and a second RAT 303 may be a UMTS, GSM, etc., system. Such systems are provided as non-limiting examples and one of ordinary skill in would understand that the processes and systems described herein may be applicable to various different RATs.

A first cell, enabled to use a first RAT 301, may include a first UE 302, an eNodeB 304, and an evolved UMTS Terrestrial Radio Access Network (EUTRAN) EMS 308. In one aspect, eNodeB 304 may include an IRAT ANR function module 306 that may be operable to receive information from first UE 302 and determine whether a new neighbor relationship may be formed for the UE 302. In another aspect, EUTRAN EMS may include an IRAT ANR control module 310 that may be operable to determine whether the new neighbor relationship may be added to a neighbor list associated with the first cell and first RAT 301.

A second cell, enabled to use a second RAT 303, may include one or more UEs, a nodeB 324, a radio network controller (RNC) 320, and a UTRAN EMS 316. In one aspect, the reciprocal IRAT ANR module 314, which is responsible for determining reciprocal neighbor relationships, may be associated with one or more network entities, such as an element management system (e.g., UTRAN EMS 316), RNC 320, and/or optionally a NMS 312. In another aspect, RNC 320 may include an IRAT NL module 322 that may be populated with the new reciprocal neighbor relationship.

In operation, reciprocal IRAT ANR module 314 may receive a notification from a network entity in a first cell, that is using a first RAT 301 (e.g., an LTE system), indicating that the cell associated with a second RAT 303 has been included in as a neighbor relation to the first cell. In one aspect, the network entity in the first cell may be EUTRAN EMS 308. Further, the neighbor relationship may be generated in the first cell when the first UE 302 associated with an eNodeB 304 in the first cell receives a signal 332 from the second cell. The UE 302 may provide information about the second cell, including the second cell RAT 303, to the IRAT ANR function module 306. Still further, the IRAT ANR function module 306 may generate a new neighbor relationship in a neighbor list (NL). The neighbor relationship may indicate the first cell as a home cell and the second cell as a neighbor cell. Thereafter, the IRAT ANR function module 306 may communicate the new neighbor relationship to the IRAT ANR control module 310 associated with the EUTRAN EMS 308. In one aspect, EUTRAN EMS 308 may communicate the new neighbor relationship to the reciprocal IRAT ANR module 314 associated with the second cell. In one aspect, where reciprocal IRAT ANR module 314 is associated with UTRAN EMS 316 for the second cell, the new neighbor relationship may be communicated using a 3GPP type 4 message 328. In another aspect, where reciprocal IRAT ANR module 314 is associated with a NMS 312, the new neighbor relationship may be communicated using a 3GPP type 2 message 330.

The reciprocal IRAT ANR module 314 may determine if a reciprocal neighbor relationship is present in the second cell. In other words, the reciprocal IRAT ANR module 314 may look for a neighbor relationship indicating the second cell as a home cell and the first cell as a neighbor cell. Upon determining that the second cell does not have a reciprocal neighbor relationship, the reciprocal IRAT ANR module 314 may generate the new reciprocal neighbor relationship. Thereafter, IRAT ANR module 314 may send a request to add the new reciprocal neighbor relationship to the IRAT NL Module 322 for the second cell. The updated neighbor list 322 may be communicated to network entities within the second cell (e.g., an RNC 320, NodeB 324, etc.).

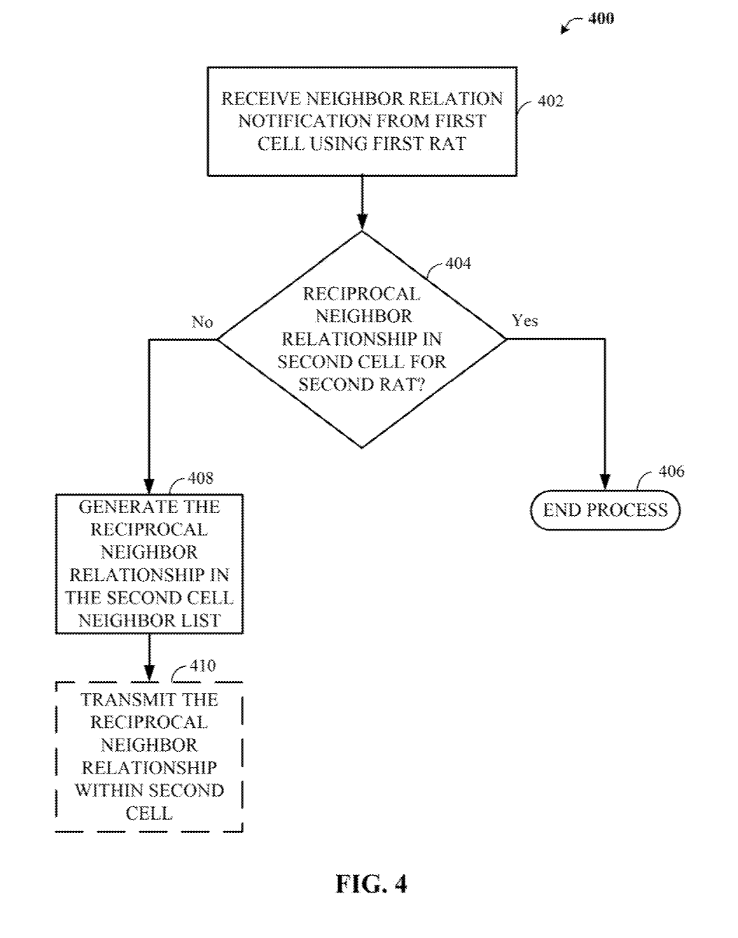

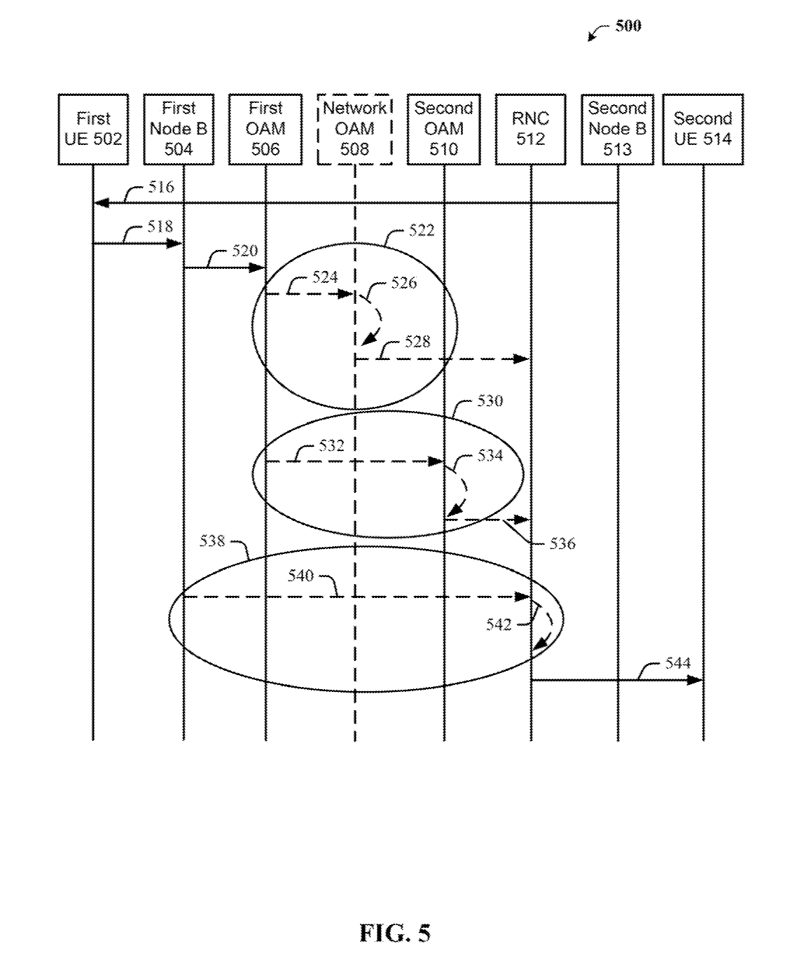

FIGS. 4 and 5 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring to FIG. 4, a process 400 is depicted for establishing inter-RAT reciprocal neighbor relationships. At block 402, a neighbor relation notification may be received from a first cell. In one aspect, the first cell may a first RAT. In one aspect, the neighbor relation notification may include a neighbor relationship of the first cell to a second cell. In one aspect, the second cell may use a second RAT that is different than the first RAT. In one aspect, means for receiving may include receiving the neighbor relation notification in response to a triggering event, such as a first cell UE detecting the second cell as a neighbor and the first cell UE transmitting information about the second cell to a first cell network entity. In such an aspect, the first cell network entity may include an eNodeB, a EUTRAN EMS, etc.

At block 404, it is determined whether a reciprocal neighbor relationship is present in the second cell for the received neighbor relationship from the neighbor relation notification. In one aspect, the determining may be performed by a network entity associated with the second cell. In one aspect, the second cell network entity may include a NMS, a UTRAN EMS, a nodeB, etc. In one aspect, the second network entity may be a NMS and the means for receiving may include means for receiving the neighbor relation notification using a 3GPP Type 2 interface protocol. In one aspect, the second network entity may be a UTRAN EMS and the means for receiving may include means for receiving the neighbor relation notification using a 3GPP Type 4 interface protocol.

If, at block 404, it is determined that a reciprocal neighbor relationship is present in the second cell for the received neighbor relationship from the neighbor relation notification, then at block 406, the process may terminate. By contrast, if at block 404 it is determined that a reciprocal neighbor relationship is not present in the second cell for the received neighbor relationship from the neighbor relation notification, then at block 408, the reciprocal neighbor relationship may be generated. Additionally in an optional aspect, the generated reciprocal neighbor relationship may be added to a neighbor list associated with the second call and may be transmitted to one or more entities associated with the second cell, at block 410.

With reference to FIG. 5, illustrated is a call flow diagram of a communication network 500 enabled to establish reciprocal inter-RAT neighbor relationships. Communication network 500 may include a first UE 502, a first nodeB 504, a first management system 506, a second management system 510, a RNC 512, a second nodeB 513 and a second UE 514. Optionally, communication network 500 may also include a network level NMS 508. At sequence step 516, first UE 502 may receive a signal from second nodeB 513 associated with RNC 512. In one aspect, the signal may be interpreted as a new cell the first UE 502 may access. At sequence step 518, the UE may communicate information about the second cell to a first nodeB 504. At sequence step 520, once the first nodeB 504 determines the second cell may be added to a neighbor list for the first cell, a notification may be sent to first EMS 506. In one aspect, the notification may include an updated neighbor list including the neighbor relationship from the first cell to the second cell.

To facilitate establishment of a reciprocal neighbor relationship in the second cell, various implementation options may be used. One or more applicable options be selected depending in part on the network architecture implemented in communication system 500.

In one option 522, communication system 500 may include a NMS 508. At sequence step 524, the neighbor relation notification may be transmitted from the first EMS 506 to the NMS 508. At sequence step 526, the NMS may determine if a reciprocal neighbor relationship is present in the second cell for the received neighbor relationship from the neighbor relation notification. If there is not a reciprocal neighbor relationship present in the second cell for the received neighbor relationship from the neighbor relation notification, then the NMS 508 may generate the request to generate reciprocal neighbor relationship. At sequence step 528, the request to generate reciprocal neighbor relationship may be communicated to one or more network entities in the second cell, such as the second EMS 510, RNC 512, or second nodeB 513.

In another option 530, at sequence step 532, first EMS 506 may transmit the neighbor relation notification to the second EMS 510. At sequence step 534, the second EMS 510 may determine if a reciprocal neighbor relationship is present in the second cell for the received neighbor relationship from the neighbor relation notification. If there is not a reciprocal neighbor relationship present in the second cell for the received neighbor relationship from the neighbor relation notification, then the second EMS 510 may generate the reciprocal neighbor relationship. At sequence step 536, the generated reciprocal neighbor relationship may be communicated to one or more network entities in the second cell, such as RNC 512 or second nodeB 513.

In another option 538, at sequence step 540, the neighbor relationship notification may be transmitted from the first nodeB 504 to the RNC 512. At sequence step 542, the RNC 512 may determine if a reciprocal neighbor relationship is present in the second cell for the received neighbor relationship from the neighbor relation notification. If there is not a reciprocal neighbor relationship present in the second cell for the received neighbor relationship from the neighbor relation notification, then the RNC 512 may generate the reciprocal neighbor relationship. Further, at sequence step 544, the second nodeB 513 may receive the updated neighbor list from RNC 512 and may transmit an updated neighbor list, including the reciprocal neighbor relationship, to a second UE 514 associated with the second cell.

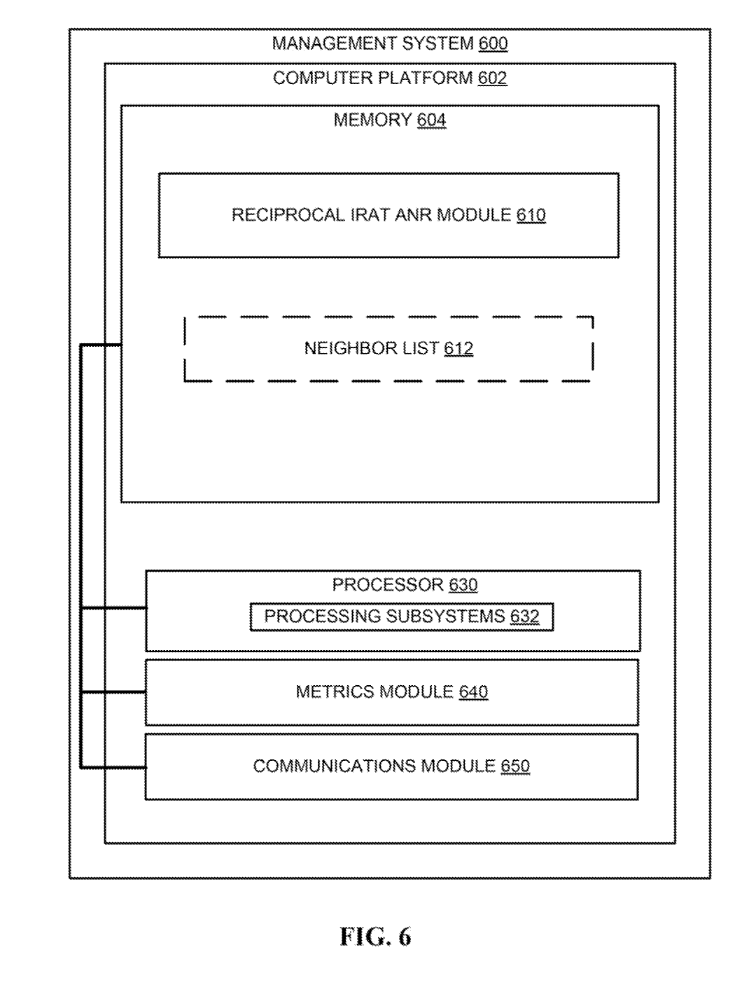

With reference to FIG. 6, illustrated is a detailed block diagram of management system 600, such as management system 230 depicted in FIG. 2. Management system 600 may comprise at least one of any type of hardware, server, personal computer, mini computer, mainframe computer, or any computing device either special purpose or general computing device. Further, the modules and applications described herein as being operated on or executed by management system 600 may be executed entirely on a single network device, as shown in FIG. 6, or alternatively, in other aspects, separate servers, databases or computer devices may work in concert to provide data in usable formats to parties, and/or to provide a separate layer of control in the data flow between communications devices 220, base stations 210, and the modules and applications executed by management system 600.

Management system 600 includes computer platform 602 that can transmit and receive data across wired and wireless networks, and that can execute routines and applications. Computer platform 602 includes memory 604, which may comprise volatile and nonvolatile memory such as read-only and/or random-access memory (ROM and RAM), EPROM, EEPROM, flash cards, or any memory common to computer platforms. Further, memory 604 may include one or more flash memory cells, or may be any secondary or tertiary storage device, such as magnetic media, optical media, tape, or soft or hard disk. Further, computer platform 602 also includes processor 630, which may be an application-specific integrated circuit (“ASIC”), or other chipset, logic circuit, or other data processing device. Processor 630 may include various processing subsystems 632 embodied in hardware, firmware, software, and combinations thereof, that enable the functionality of reciprocal IRAT ANR module module 610 and the operability of the network device on a wired or wireless network.

Processor 630 may be operable to provide means for receiving a neighbor relation notification from a first entity, wherein the neighbor relation notification indicates a neighbor relationship of a first cell to a second cell, wherein the first cell uses a first radio access technology (RAT), and wherein the second cell uses a second RAT that is different than the first RAT, means for determining, by a second network entity, that a reciprocal neighbor relationship of the second cell to the first cell does not exist in a neighbor list for the second cell, and means for generating the reciprocal neighbor relationship. In another aspect, the processor 630 may provide means for updating the neighbor list of the second cell with the generated reciprocal neighbor relationship. In another aspect, the processor 630 may provide means for receiving the neighbor relation notification using a 3GPP Type 2 interface protocol. In another aspect, the processor 630 may provide means for receiving the neighbor relation notification using a 3GPP Type 4 interface protocol. Processor 630 may further include at least one processor enabled to perform one or more of the above described means.

Computer platform 602 further includes communications module 650 embodied in hardware, firmware, software, and combinations thereof, that enables communications among the various components of management system 600, as well as between management system 600 and base stations 210. Communication module 650 may include the requisite hardware, firmware, software and/or combinations thereof for establishing a wireless communication connection. According to described aspects, communication module 650 may include the necessary hardware, firmware and/or software to facilitate wireless broadcast, multicast and/or unicast communication of requested cell performance measurements, cell efficiency coefficients, network modification suggestions, etc. In one aspect, communication module 650 may include one or more transmitter, one or more receiver, one or more transmit antennas, one or more reception antennas, etc.

Computer platform 602 further includes metrics module 640, embodied in hardware, firmware, software, and combinations thereof, that enables metrics received from base stations 210 corresponding to among other things, data communicated from devices 220. In one aspect, management system 600 may analyze data received through metrics module 640 to generate cell neighbor relationships, network modification suggestions, etc.

Memory 604 of management system 600 includes include a reciprocal IRAT ANR module 610 to enable management system 600 to establish IRAT reciprocal neighbor relationships. Additionally and/or optionally, management system 600 may further include an IRAT neighbor list (NL) module 612 that may be operable to populate a cell NL with reciprocal neighbor relationships determined by the reciprocal IRAT ANR module 610. Further discussion of IRAT ANR module 610 is provided with reference to FIGS. 4 and 5.

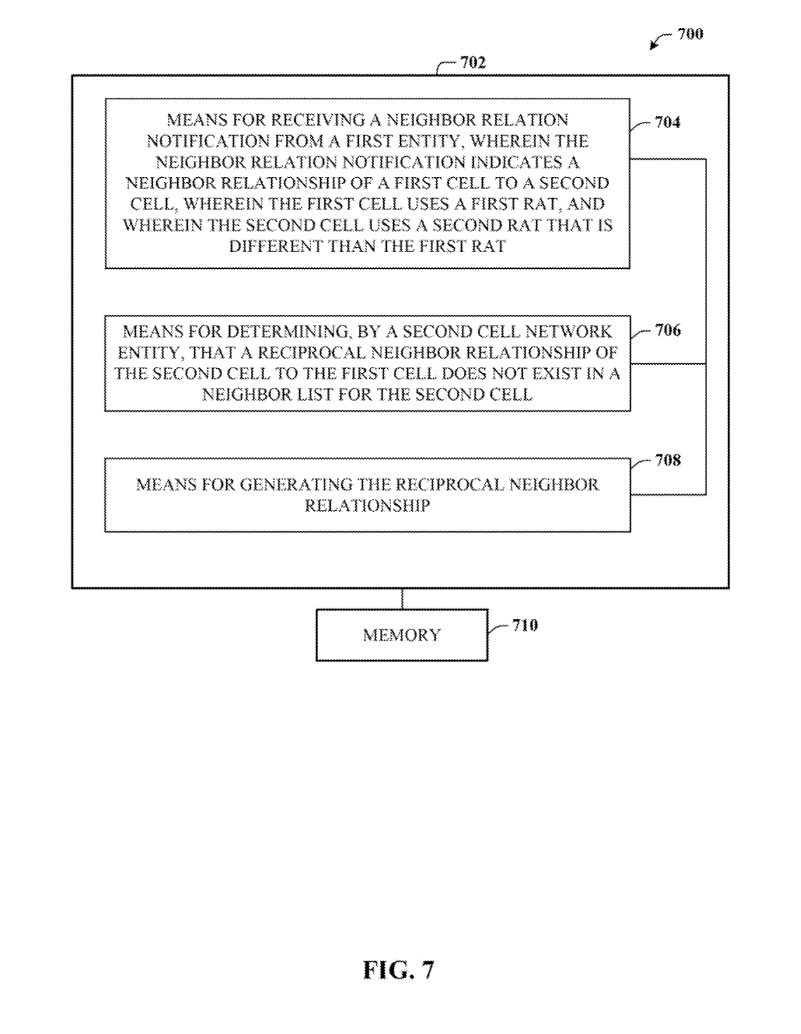

With reference to FIG. 7, a block diagram of an example system 700 that can establish inter-RAT reciprocal neighbor relationships is illustrated. For example, system 700 can reside at least partially within a network entity, such as a NMS, an EMS, an RNC, a nodeB, an eNodeB, etc. It is to be appreciated that system 700 is represented as including functional blocks, which can be functional blocks that represent functions implemented by a processor, software, or combination thereof (e.g., firmware).

System 700 includes a logical grouping 702 of means that can act in conjunction. For instance, logical grouping 702 can include means for receiving a neighbor relation notification from a first cell 704. In one aspect, the first cell may a first RAT. In one aspect, the neighbor relation notification may include a neighbor relationship of the first cell to a second cell. In one aspect, the second cell may use a second RAT that is different than the first RAT. In one aspect, means for receiving may include receiving the neighbor relation notification in response to a triggering event, such as a first cell UE detecting the second cell as a neighbor and the first cell UE transmitting information about the second cell to a first cell network entity. In such an aspect, the first cell network entity may include an eNodeB, a EUTRAN OAM, etc.

Further, logical grouping 702 can comprise means for determining, by a second cell network entity, that a reciprocal neighbor relationship of the second cell to the first cell does not exist in a neighbor list for the second cell 706. In one aspect, the second cell network entity may include a network OAM, a UTRAN OAM, a nodeB, etc. In one aspect, the second network entity may be a network OAM and the means for receiving may include means for receiving the neighbor relation notification using a 3GPP Type 2 message. In one aspect, the second network entity may be a UTRAN OAM and the means for receiving may include means for receiving the neighbor relation notification using a 3GPP Type 4 message.

Further, logical grouping 702 can comprise means for generating the reciprocal neighbor relationship 708. In one aspect, the first RAT may be LTE and the second RAT may be UMTS, GSM, etc.

Additionally, system 700 can include a memory 710 that retains instructions for executing functions associated with the means 704, 706 and 708. While shown as being external to memory 710, it is to be understood that one or more of the means 704, 706 and 708 can exist within memory 710.

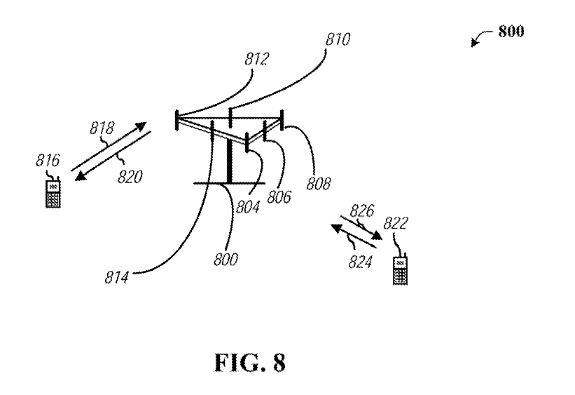

Referring to FIG. 8, a multiple access wireless communication system according to one aspect is illustrated. An access point 800 (AP) includes multiple antenna groups, one including 804 and 806, another including 808 and 810, and an additional including 812 and 814. In FIG. 8, only two antennas are shown for each antenna group, however, more or fewer antennas may be utilized for each antenna group. Access terminal 816 (AT) is in communication with antennas 812 and 814, where antennas 812 and 814 transmit information to access terminal 816 over forward link 820 and receive information from access terminal 816 over reverse link 818. Access terminal 822 is in communication with antennas 806 and 808, where antennas 806 and 808 transmit information to access terminal 822 over forward link 826 and receive information from access terminal 822 over reverse link 824. In a FDD system, communication links 818, 820, 824 and 826 may use different frequency for communication. For example, forward link 820 may use a different frequency then that used by reverse link 818.

Each group of antennas and/or the area in which they are designed to communicate is often referred to as a sector of the access point. In the aspect, antenna groups each are designed to communicate to access terminals in a sector, of the areas covered by access point 800.

In communication over forward links 820 and 826, the transmitting antennas of access point 800 utilize beamforming in order to improve the signal-to-noise ratio of forward links for the different access terminals 816 and 822. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as an access point, a NodeB, or some other terminology. An access terminal may also be called an access terminal, user equipment (UE), a wireless communication device, terminal, access terminal or some other terminology.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a NodeB, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An example storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. A method for wireless communications, comprising:
receiving a neighbor relation notification from a first entity, wherein the neighbor relation notification indicates a neighbor relationship of a first cell to a second cell, wherein the first cell uses a first radio access technology (RAT), and wherein the second cell uses a second RAT that is different than the first RAT;
determining, by a second network entity, that a reciprocal neighbor relationship of the second cell to the first cell does not exist in a neighbor list for the second cell; and
generating the reciprocal neighbor relationship.

2. The method of claim 1, further comprising:
updating the neighbor list of the second cell with the generated reciprocal neighbor relationship.

3. The method of claim 1, wherein the first entity comprises at least one of a network management system, an element management system, RNC or an eNodeB.

4. The method of claim 1, wherein the second network entity comprises at least one of a network management system, an element management system, RNC or an eNodeB.

5. The method of claim 1, wherein the receiving comprises receiving the neighbor relation notification using a 3GPP Type 2 interface protocol.

6. The method of claim 1, wherein the receiving comprises receiving the neighbor relation notification using a 3GPP Type 4 interface protocol.

7. The method of claim 1, wherein the first RAT is LTE and wherein the second RAT is either UMTS or GSM.

8. At least one processor configured to establish inter RAT reciprocal neighbor relationships, the processor comprising:
a first module for receiving a neighbor relation notification from a first entity, wherein the neighbor relation notification indicates a neighbor relationship of a first cell to a second cell, wherein the first cell uses a first RAT, and wherein the second cell uses a second RAT that is different than the first RAT;
a second module for determining, by a second network entity, that a reciprocal neighbor relationship of the second cell to the first cell does not exist in a neighbor list for the second cell; and
a third module for generating the reciprocal neighbor relationship.

9. A computer program product, comprising:
a non-transitory computer-readable medium comprising:
a first set of codes for causing a computer to receive a neighbor relation notification from a first entity, wherein the neighbor relation notification indicates a neighbor relationship of a first cell to a second cell, wherein the first cell uses a first RAT, and wherein the second cell uses a second RAT that is different than the first RAT;
a second set of codes for causing the computer to determine, by a second network entity, that a reciprocal neighbor relationship of the second cell to the first cell does not exist in a neighbor list for the second cell; and
a third set of codes for causing the computer to generate the reciprocal neighbor relationship.

10. An apparatus, comprising:
means for receiving a neighbor relation notification from a first entity, wherein the neighbor relation notification indicates a neighbor relationship of a first cell to a second cell, wherein the first cell uses a first RAT, and wherein the second cell uses a second RAT that is different than the first RAT;
means for determining, by a second cell network entity, that a reciprocal neighbor relationship of the second cell to the first cell does not exist in a neighbor list for the second cell; and
means for generating a plurality of cell efficiency coefficients for each of the plurality of base stations by processing the obtained cell performance measurements.

11. The apparatus of claim 10, further comprising:
means for updating the neighbor list of the second cell with the generated reciprocal neighbor relationship.

12. The apparatus of claim 10, wherein the means for receiving comprises means for receiving the neighbor relation notification using a 3GPP Type 2 interface protocol.

13. The apparatus of claim 10, wherein the means for receiving comprises means for receiving the neighbor relation notification using a 3GPP Type 4 interface protocol.

14. An apparatus for wireless communications, comprising:
a communications module for:
receiving a neighbor relation notification from a first entity, wherein the neighbor relation notification indicates a neighbor relationship of a first cell to a second cell, wherein the first cell uses a first RAT, and wherein the second cell uses a second RAT that is different than the first RAT; and
a reciprocal inter RAT automatic neighbor relations (IRAT ANR) module for:
determining, by a second network entity, that a reciprocal neighbor relationship of the second cell to the first cell does not exist in a neighbor list for the second cell; and
generating the reciprocal neighbor relationship.

15. The apparatus of claim 14, wherein reciprocal IRAT ANR module is further operable for updating the neighbor list of the second cell with the generated reciprocal neighbor relationship.

16. The apparatus of claim 14, wherein the first entity comprises at least one of a network management system, an element management system, RNC or an eNodeB.

17. The apparatus of claim 14, wherein the second network entity comprises at least one of a network management system, an element management system, RNC or an eNodeB.

18. The apparatus of claim 14, wherein the communication module is further operable for:
receiving the neighbor relation notification using a 3GPP Type 2 interface protocol.

19. The apparatus of claim 14, wherein the communications module is further operable for receiving the neighbor relation notification using a 3GPP Type 4 interface protocol.

20. The apparatus of claim 14, wherein the first RAT is LTE and wherein the second RAT is either UMTS or GSM.
